(19) United States
(12) Patent Application Publication
(10) Pub. No.: US 2009/0259725 A1
(43) Pub. Date: Oct. 15, 2009

(54) EMAIL CONSUMER REPUTATION

(75) Inventor: Michael RABINOVICH, Solon, OH (US)

Correspondence Address: KRAGULJAC & KALNAY, 4700 ROCKSIDE ROAD, SUMMIT ONE, SUITE 510, INDEPENDENCE, OH, 44131, US

(73) Assignee: CASE WESTERN RESERVE UNIVERSITY, Cleveland, OH (US)

(21) Appl. No.: 12/423,114

(22) Filed: Apr. 14, 2009

Related U.S. Application Data
(60) Provisional application No. 61/124,088, filed on Apr. 14, 2008.

(51) Int. Cl. G06F 15/16

(52) U.S. Cl. 709/206

(57) ABSTRACT

Systems, methods, and other embodiments associated with email address consumer reputation are described. One example method includes detecting a provision of an email address to an email address consumer. The example method may also include warning a user that the email address consumer may be associated with undesirable email traffic upon determining that the email address consumer satisfies a standard based on data acquired from a reputation system.

### PRIORITY CLAIM

This application claims the benefit of provisional application No. 61/124,088 titled Spammer Tree Root Node Identification filed Apr. 14, 2008.

### BACKGROUND

Electronic mail systems facilitate fast, asynchronous communication between users. Over time, people have been increasingly using email as a tool for swift and/or private communication. As a result, companies have begun using email as a way to stay connected with current customers and as a way to advertise to potential customers. Unsolicited advertisements, also known as spam, are often considered annoying by their recipients. Additionally, large quantities of spam may be burdensome and even require expensive solutions for keeping spam under control. Furthermore, some spam messages may contain malicious attachments and/or links to malware designed to infiltrate or damage a system without user consent.

Thus, techniques exist for detecting and blocking spam. Some conventional techniques employ filters to reduce or block unsolicited emails. These systems have varying degrees of success depending on the quality of the filter. In other systems, multiple email addresses are employed to attempt to reduce the amount of spam sent to an email address a user considers important. However, some companies require the input of an email address when applying for services. Additionally, even closely guarded email addresses may be compromised by poor standards and/or practices being implemented by parties with which email addresses have been shared. Thus, spam will typically start to show up in mail boxes over time. The rate of incoming spam may increase as the sources of unsolicited emails become more sophisticated in their email address collection and in their techniques used to distribute the spam.

### BRIEF DESCRIPTION OF THE DRAWINGS

The accompanying drawings, which are incorporated in and constitute a part of the specification, illustrate various example systems, methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 illustrates an example method associated with email address consumer reputation.

FIG. 2 illustrates an example method associated with email address consumer reputation.

FIG. 3 illustrates an example method associated with email address consumer reputation.

FIG. 4 illustrates an example method associated with email address consumer reputation.

FIG. 5 illustrates an example method associated with email address consumer reputation.

FIG. 6 illustrates an example system associated with email address consumer reputation.

FIG. 7 illustrates an example computing environment in which example systems and methods, and equivalents, may operate.

### DETAILED DESCRIPTION

Example systems and methods associated with email address consumer reputation are described. In one example, outgoing signals may be monitored for a provision of an un-aliased email to an email address consumer. An email address consumer may be, for example, a web form, a destination of a web form, an outgoing email, a destination of an outgoing email, a product registration form, a destination of a registration form, and so on. The un-aliased email address may be replaced in an outgoing signal with an alias email address and an association between the alias email address and the email address consumer may be stored.

Information related to an alias email address may be presented to a spam distinguishing entity. In one example, a spam distinguishing entity may be a user and the information may be presented in response to a request to reveal the identity of an email address consumer associated with an alias email address. The user may request this information if the user decides that an undesirable amount of spam is arriving in the user's inbox. In one example, the information may facilitate exposing the party or parties that are (in)directly responsible for received email that the user deems to be undesirable (e.g., spam). In one example, a spam distinguishing entity may be a logic configured to determine if spam is being sent to the alias email address. In one example, requesting information relating to an alias email address may affect a value in a reputation system that is associated with an email address consumer associated with the alias email address. Additionally, if the spam distinguishing entity determines that an alias email address is receiving an undesirable amount of unsolicited email, the spam distinguishing entity may initiate an action that further affects the value in the reputation system.

Managing alias email addresses using example systems and methods may facilitate tracking sources of undesirable email. If a user determines that a source of incoming spam is a web form of a company, the user may modify their habits to reduce the incoming spam from that source. In another example, if the user determines that a source of incoming spam is a contact, the user may be able to notify the contact that the contact's computer may be compromised. In either case, the user may be able to restrict email communications that are directed to an alias email address that is receiving undesirable email.

Additionally, some described examples facilitate monitoring user actions as they react to spam. This may allow input for a reputation system for email address consumers to be automatically generated. In one example, the reputation system may combat spam by leveraging distributed efforts to identify and neutralize abusers. Input to the reputation system may occur as a side effect of self-serving user behavior (e.g., revealing and blocking alias email addresses). By way of illustration, some reputation scores may be bound to web sites providing web forms for entering email addresses. Unlike a forged email identity from which a spam email itself may originate, a web site would have to be a properly registered domain name system (DNS) name. This may make it more difficult for a company to obfuscate a relationship with undesirable email traffic. This may discourage some companies from selling email address data to companies that traffic in spam and as a result may reduce spam trafficking overall.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

ASIC: application specific integrated circuit.

CD: compact disk.

CD-R: CD recordable.

CD-RW: CD rewriteable.

DVD: digital versatile disk and/or digital video disk.

HTTP: hypertext transfer protocol.

LAN: local area network.

PCI: peripheral component interconnect.

PCIE: PCI express.

RAM: random access memory.

DRAM: dynamic RAM.

SRAM: synchronous RAM.

ROM: read only memory.

PROM: programmable ROM.

USB: universal serial bus.

WAN: wide area network.

“Computer component”, as used herein, refers to a computer-related entity (e.g., hardware, firmware, software in execution, combinations thereof). Computer components may include, for example, a process running on a processor, a processor, an object, an executable, a thread of execution, and a computer. A computer component(s) may reside within a process and/or thread. A computer component may be localized on one computer and/or may be distributed between multiple computers.

“Computer communication”, as used herein, refers to a communication between computing devices (e.g., computer, personal digital assistant, cellular telephone) and can be, for example, a network transfer, a file transfer, an applet transfer, an email, an HTTP transfer, and so on. A computer communication can occur across, for example, a wireless system (e.g., IEEE 802.11), an Ethernet system (e.g., IEEE 802.3), a token ring system (e.g., IEEE 802.5), a LAN, a WAN, a point-to-point system, a circuit switching system, a packet switching system, and so on.

“Computer-readable medium”, as used herein, refers to a medium that stores signals, instructions and/or data. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device can read.

In some examples, “database” is used to refer to a table. In other examples, “database” may be used to refer to a set of tables. In still other examples, “database” may refer to a set of data stores and methods for accessing and/or manipulating those data stores.

“Data store”, as used herein, refers to a physical and/or logical entity that can store data. A data store may be, for example, a database, a table, a file, a data structure (e.g. a list, a queue, a heap, a tree) a memory, a register, and so on. In different examples, a data store may reside in one logical and/or physical entity and/or may be distributed between two or more logical and/or physical entities.

“Logic”, as used herein, includes but is not limited to hardware, firmware, software in execution on a machine, and/or combinations of each to perform a function(s) or an action(s), and/or to cause a function or action from another logic, method, and/or system. Logic may include a software controlled microprocessor, a discrete logic (e.g., ASIC), an analog circuit, a digital circuit, a programmed logic device, a memory device containing instructions, and so on. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, software). Logical and/or physical communication channels can be used to create an operable connection.

“Signal”, as used herein, includes but is not limited to, electrical signals, optical signals, analog signals, digital signals, data, computer instructions, processor instructions, messages, a bit, a bit stream, and so on, that can be received, transmitted and/or detected.

“Software”, as used herein, includes but is not limited to, one or more executable instruction that cause a computer, processor, or other electronic device to perform functions, actions and/or behave in a desired manner. “Software” does not refer to stored instructions being claimed as stored instructions per se (e.g., a program listing). The instructions may be embodied in various forms including routines, algorithms, modules, methods, threads, and/or programs including separate applications or code from dynamically linked libraries.

“User”, as used herein, includes but is not limited to one or more persons, software, logics, computers or other devices, or combinations of these.

Some portions of the detailed descriptions that follow are presented in terms of algorithms and symbolic representations of operations on data bits within a memory. These algorithmic descriptions and representations are used by those skilled in the art to convey the substance of their work to others. An algorithm, here and generally, is conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic, and so on. The physical manipulations create a concrete, tangible, useful, real-world result.

It has proven convenient at times, principally for reasons of common usage, to refer to these signals as bits, values, elements, symbols, characters, terms, numbers, and so on. It should be borne in mind, however, that these and similar terms are to be associated with the appropriate physical quantities and are merely convenient labels applied to these quantities. Unless specifically stated otherwise, it is to be appreciated that throughout the description, terms including processing, computing, determining, and so on, refer to actions and processes of a computer system, logic, processor, or similar electronic device that manipulates and transforms data represented as physical (electronic) quantities.

Example methods may be better appreciated with reference to flow diagrams. For purposes of simplicity of explanation, the illustrated methodologies are shown and described as a series of blocks. However, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

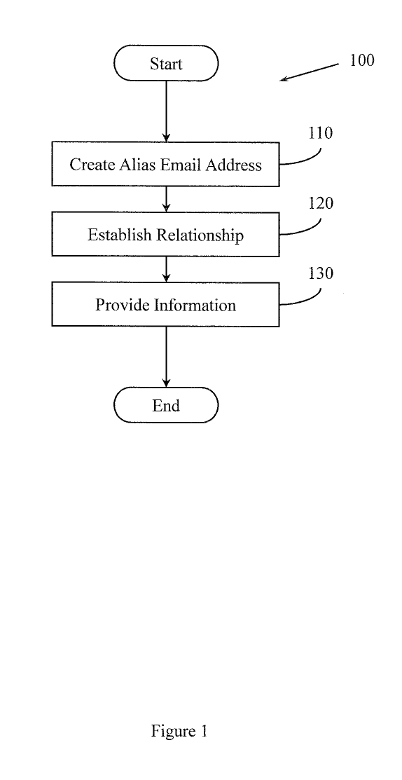

FIG. 1 illustrates a method 100 associated with email address consumer reputation. Method 100 includes, at 110, creating an alias email address. The alias email address may be created upon detecting an initial provision of an un-aliased email address to an email address consumer. An email address consumer may be one of, a web form, a destination of a web form, an outgoing email, a destination of an outgoing email, a product registration form, a destination of a product registration form, and so forth. More generally, an email address consumer may be a person, company, website, list, and so forth to which a user may provide an email address. Creating the alias email address may include replacing the un-aliased email address with the alias email address in a signal that triggered the detection.

Method 100 also includes, at 120, establishing a relationship between the alias email address and the email address consumer. Method 100 also includes, at 130, providing data associated with the email address consumer to a spam distinguishing entity. The data associated with the email address consumer may be provided in response to receiving a reveal signal from the spam distinguishing entity. A spam distinguishing entity may be a user or a logic. Thus, the reveal signal may originate from a user input when a user decides that an email received by an alias email address is an undesirable email (e.g., spam). In one example creating the alias email address at 110 and establishing the relationship at 120 may comprise creating an alias email address containing the relationship. For example, a cryptographic technique may be employed to mask the email address consumer in the alias email address. In another example, establishing the relationship at 120 may comprise storing data linking the alias email address and the email address consumer to a memory (e.g., a database). A person having ordinary skill in the art can recognize other ways of establishing a relationship between the email address consumer and the alias email address.

By way of illustration, a leader of a band, Jon, may be deciding whether to purchase a guitar online from a musical equipment company. When filling out personal information in a web form, the company may request that an email be provided for contact purposes. Thus, a computer performing method 100 may automatically detect Jon's provision of his email address to the company, create an alias email address, and replace Jon's real email address with the alias email address in the web form. Unbeknownst to Jon, the musical equipment company may sell email addresses to other companies that advertise by sending emails. Jon may prefer not to receive these emails. If Jon determines he may be receiving spam in his inbox, Jon may ask that a source of an undesirable email be revealed. Because the musical equipment company has been selling the alias email address, and not Jon's real email address, a computer performing method 100 may be able to tell Jon that the musical equipment company has been trafficking email addresses. This may allow Jon to amend his future purchasing practices to not include the musical equipment company.

While FIG. 1 illustrates various actions occurring in serial, it is to be appreciated that various actions illustrated in FIG. 1 could occur substantially in parallel. By way of illustration, a first process could create an alias email address, a second process could establish a relationship, and a third process could provide data associated with the email address consumer. While three processes are described, it is to be appreciated that a greater and/or lesser number of processes could be employed and that lightweight processes, regular processes, threads, and other approaches could be employed.

In one example, a method may be implemented as computer executable instructions. Thus, in one example, a computer-readable medium may store computer executable instructions that if executed by a machine (e.g., processor) cause the machine to perform a method. While executable instructions associated with the above method are described as being stored on a computer-readable medium, it is to be appreciated that executable instructions associated with other example methods described herein may also be stored on a computer-readable medium.

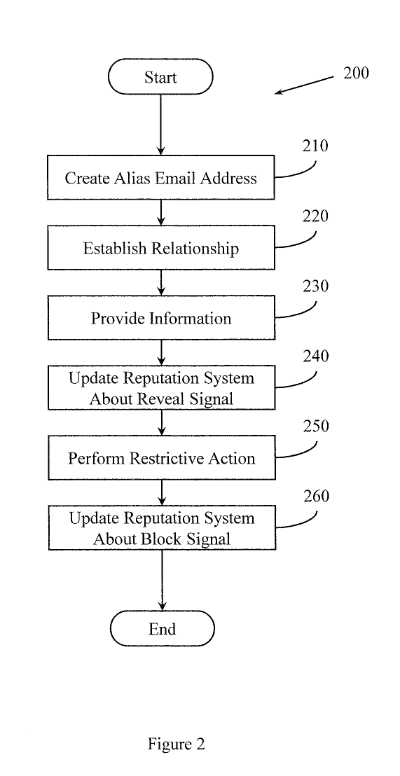

FIG. 2 illustrates a method 200 associated with email address consumer reputation. Method 200 includes several actions similar to those described in connection with method 100 (FIG. 1). For example, method 200 includes creating an alias email address at 210, establishing a relationship at 220, and providing information at 230. However, method 200 includes additional actions.

Method 200 includes, at 240, updating a reputation system based on the reveal signal. The reputation system may be an external system associated with a database that tracks reputations for a number of email address consumers. By receiving input from a distributed network of spam distinguishing entities, the reputation system may be able to identify email address consumers that facilitate distribution of undesirable emails (e.g., a company that sells email addresses to other companies). Method 200 also includes, at 250, performing a restrictive action associated with the alias email address. The restrictive action may be performed upon receiving a block signal from the spam distinguishing entity identifying the alias email address. The restrictive action may include configuring an email filter associated with the alias email address, blocking an incoming signal associated with the alias email address, modifying a routing setting to block an incoming signal associated with the alias email address, applying a sieve algorithm to a signal associated with the alias email address, and so forth. Thus, the restrictive action may attempt to prevent future undesirable emails that identify the alias email address from arriving at the un-aliased email address.

Method 200 also includes, at 260, updating the reputation system based on the block signal. In one example, updating the reputation system based on a block signal may have an impact on a rating associated with an email address consumer that is more detrimental to the rating than an update to the reputation system based on a reveal signal. Thus, a reveal signal may indicate that a user has received an email that has annoyed the user enough to arouse the interest regarding of the source of the email, while a block signal may indicate that the user is sure that the source of the email is related to undesirable email traffic.

By way of illustration, method 200 may allow Jon's revelation of the email trafficking by the musical equipment company to be fed back into a reputation system. Method 200 may also allow Jon to restrict and/or block emails arriving at the alias email address associated with the musical equipment company. Blocking emails in this manner may further impact the reputation of the musical equipment company. Over time, if many users repeatedly reveal and/or block alias email addresses associated with the musical equipment company, the rating may begin to impact the business of the musical equipment company thereby potentially causing the company to amend its email trafficking practices.

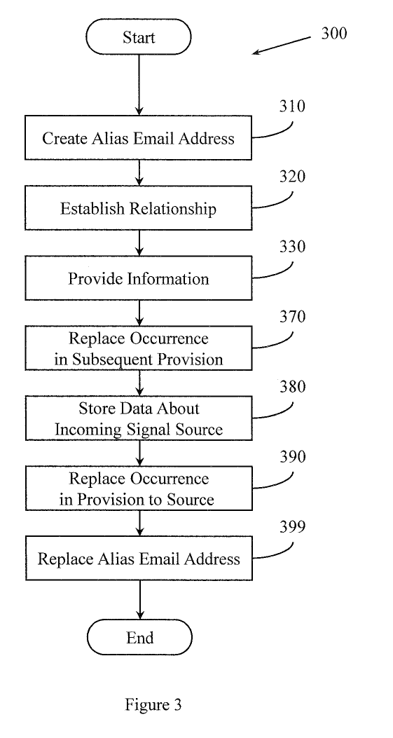

FIG. 3 illustrates a method 300 associated with email address consumer reputation. Method 300 includes several actions similar to those described in connection with method 100 (FIG. 1). For example, method 300 includes creating an alias email address at 310, establishing a relationship at 320, and providing information at 330. However, method 300 includes additional actions.

Method 300 includes, at 370, replacing an occurrence of the un-aliased email address with the alias email address upon detecting a subsequent provision of the un-aliased email address to the email address consumer. This may facilitate ensuring that the un-aliased email address is not provided to the email address consumer. Replacing the occurrence of the un-aliased email address may be based on the relationship between the alias email address and the email address consumer. Method 300 also includes, at 380, storing data associated with a source of an incoming email address upon determining that the incoming email address indentifies the alias email address. The source may be a related email address consumer to whom the email address consumer has provided the alias email address. Method 300 also includes, at 390, replacing an occurrence of the un-aliased email address with the alias email address upon detecting a provision of the un-aliased email address to the source of the incoming email address. The replacement may be based on the data associated with the source of the incoming email address. Thus, method 300 may illustrate more sophisticated ways of tracking of email address trafficking. Method 300 may allow a computer to ensure that a standardized alias email address is used for communications with an email address consumer and with related email address consumers to whom the email address consumer has provided the alias email address.

By way of illustration, a computer performing method 300 may be able to ensure that communications between a user and an original email address consumer are associated with a first alias email address that was created for the original email address consumer. At a later point, the original email address consumer may provide the first alias email address to a related email address consumer and the related email address consumer may attempt to reach the user by sending an email to the first alias email address. In this case, a computer performing method 300 may associate the first alias email address with the related email address consumer upon receiving the email from the related email address consumer. The computer may then begin to replace occurrences of the un-aliased email address with the first alias email address in communications to the related email address consumer. This may allow the computer to track how the first alias email address spreads from the original email address consumer. However, while associating the first alias email address with the related email address consumer is described, a person having ordinary skill in the art may recognize advantages for creating a second alias email address for subsequent communications to the related email address consumer.

Method 300 also includes, at 399, replacing an occurrence of the alias email address with the un-aliased email address in an incoming signal. In one example, the occurrence may be replaced in signals as they arrive. In another example, replacement may be performed when the alias email address would be displayed to a user. A person having ordinary skill in the art may recognize other situations when replacement of the alias email address with the un-aliased email address may be advantageous. Replacing the alias email address with the un-aliased email address may facilitate user transparent alias email address handling. User transparent email address handling may allow a user to continue to use their un-aliased email address as they would without a computer that does not facilitate described examples. For example, user transparent email address handling may make it so the user does not have to manage potentially encrypted alias email addresses manually. Thus, by performing automatic replacements so that alias email address handling is user transparent, greater consistency when providing alias email addresses may be achieved because potential user introduced errors may be reduced.

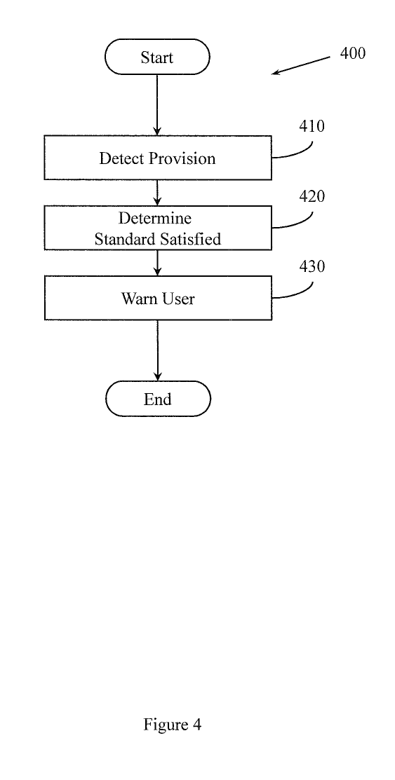

FIG. 4 illustrates a method 400 associated with email address consumer reputation. Method 400 includes, at 410, detecting a provision of an email address to an email address consumer. Method 400 also includes, at 420, determining whether the email address consumer satisfies a spam standard. The determination may be based on data acquired from a reputation system. In one example, the data from the reputation system may be stored in a memory accessible by a computer performing method 400. In another example, the data from the reputation system may be provided by the reputation system in response to a request. While two distribution methods for reputation data are described, a person having ordinary skill in the art may recognize other ways to ensure that data from the reputation system is available to computers implementing an embodiment of method 400. Method 400 also includes, at 430, warning a user that the email address consumer may be associated with undesirable email traffic. Warning users that they may be about to provide an email address to an email address consumer associated with undesirable email traffic may cause users to reconsider whether the action about to be performed is worth the potential risk of receiving spam.

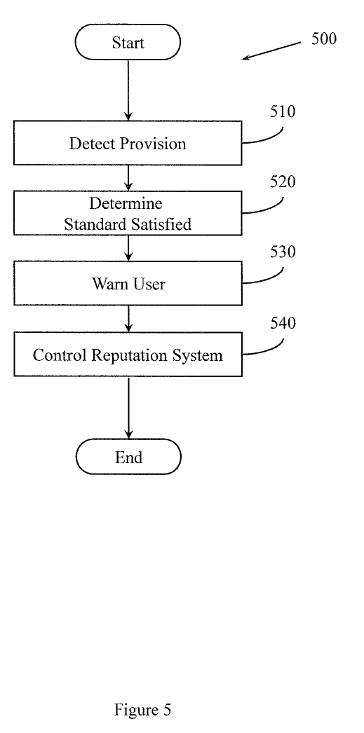

FIG. 5 illustrates a method 500 associated with email address consumer reputation. Method 500 includes several actions similar to those described in connection with method 400 (FIG. 4). For example, method 500 includes detecting a provision at 510, determining whether a standard has been satisfied at 520, and warning a user at 530. However, method 500 also includes, at 540, controlling the reputation system. In one example, the reputation system may be controlled to update data associated with a revealed email address consumer in response to receiving a reveal signal from the user. The reveal signal may identify the revealed email address consumer. In another example, the reputation system may be controlled to update data associated with a blocked email address consumer in response to receiving a block signal from the user. As above, the block signal may identify the blocked email address consumer. While two situations for updating the reputation system are described, a person having ordinary skill in the art can see how there may be other situations where updating the reputation system may be appropriate.

By way of illustration, method 500 illustrates how users may interact with a reputation system. If Jon is trying to decide which of several companies to purchase a drum kit for his band-mate Tico, Jon's decision may be influenced by knowing if one of the companies is likely to cause spam to arrive in Jon's inbox. Further, as described above, method 500 may also facilitate updating data in the reputation system based on actions taken in response to received undesirable emails.

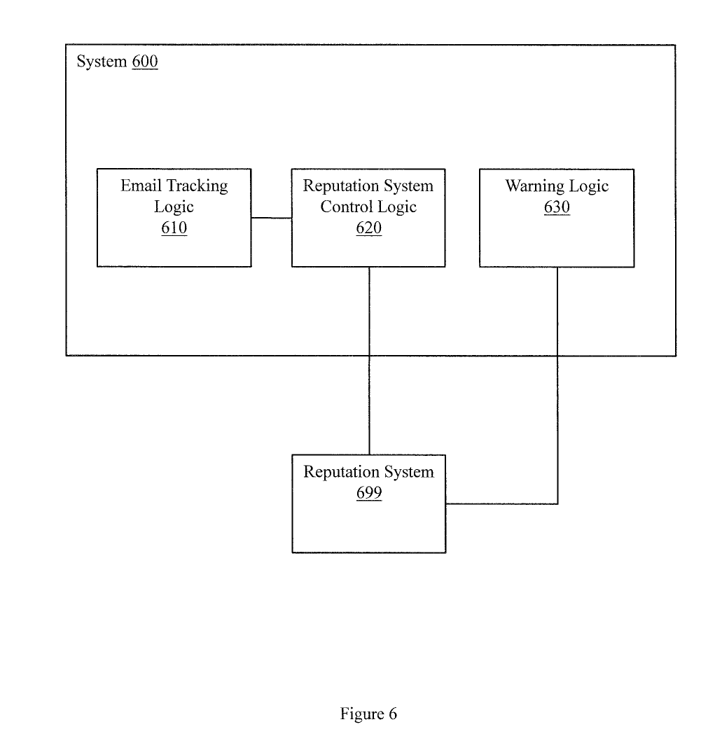

FIG. 6 illustrates a system 600 associated with email address consumer reputation. System 600 includes an email tracking logic 610. Email tracking logic 610 may manage a set of signals associated with an email address. Managing the set of signals may include creating an alias email address when a user attempts to provide an un-aliased email address to a tracked email address consumer. Managing the set of signals may also include storing an association between the alias email address and the tracked email address consumer. Managing the set of signals may also include performing an action associated with the tracked email address consumer in response to receiving an action signal from the user. The action signal may identify the alias email address. The action signal may be one of, a reveal signal, a block signal, and so forth. The action may be one of, providing data associated with the tracked email address consumer to the user, performing a restrictive action associated with the alias email address, and so forth. As described above the restrictive action may include blocking incoming signals associated with the alias email address, configuring a router to block incoming signals associated with an alias email address, and so forth. Managing the set of signals may also include replacing an occurrence of an un-aliased email address with an alias email address in an outgoing signal. Thus, tracking logic 610 may facilitate alias email address management that is transparent to users. While an example system may allow sophisticated users advanced control over alias email address configurations, a typical user may not be interested in advanced control of spam management and may only worry about the alias email address details when attempting to block future spam from an email address. In another example, user transparency may be enhanced by replacing occurrences of the alias email address with the un-aliased email address in incoming signals.

System 600 also includes a reputation system control logic 620. Reputation system control logic 620 may control a reputation system 699 to update data associated with the tracked email address consumer. Controlling reputation system 699 may be based on the set of signals associated with the email address. In one example, actions performed by reputation system control logic 620 may be initiated as a part of signal management performed by email tracking logic 610. System 600 also includes a warning logic 630. Warning logic 630 may warn a user that a recipient email address consumer may be associated with undesirable email traffic. Warning logic 630 may provide this warning upon detecting a provision of the email address to the recipient email address consumer and upon determining that the recipient email address consumer satisfies a spam standard based on data from reputation system 699.

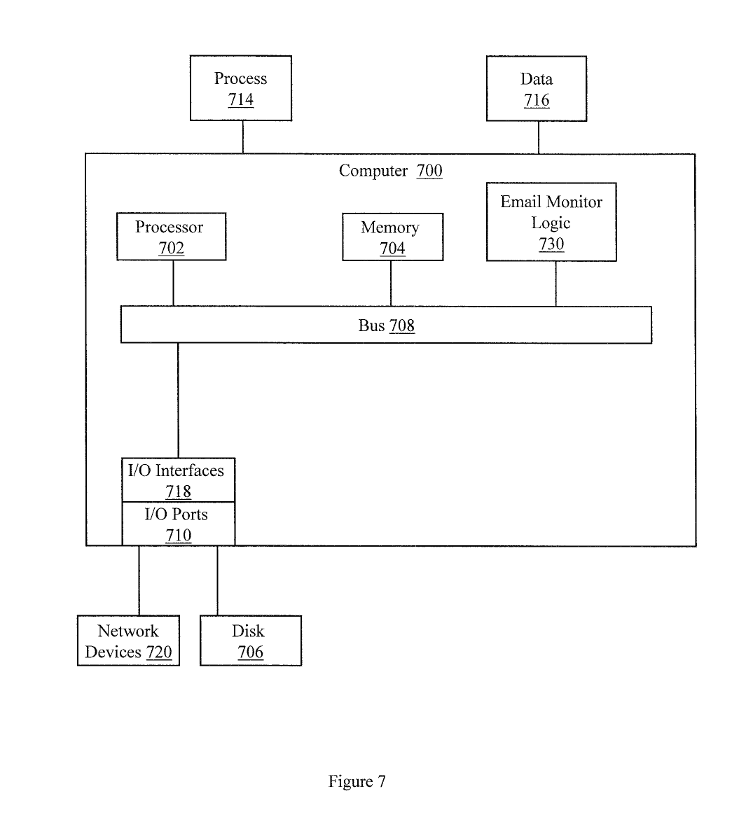

FIG. 7 illustrates an example computing device in which example systems and methods described herein, and equivalents, may operate. The example computing device may be a computer 700 that includes a processor 702, a memory 704, and input/output ports 710 operably connected by a bus 708. In one example, the computer 700 may include an email monitor logic 730. In different examples, the logic 730 may be implemented in hardware, software, firmware, and/or combinations thereof. While the logic 730 is illustrated as a hardware component attached to the bus 708, it is to be appreciated that in one example, the logic 730 could be implemented in the processor 702.

Logic 730 may provide means (e.g., hardware, software, firmware) for managing signals associated with an email address. Logic 730 may also provide means (e.g., hardware, software firmware) for controlling a reputation system based on the signals associated with the email address. Logic 730 may also provide means for warning a user that an email address consumer may be associated with undesirable email traffic based on data from the reputation system. The means associated with logic 730 may be implemented, for example, as an ASIC. The means may also be implemented as computer executable instructions that are presented to computer 700 as data 716 that are temporarily stored in memory 704 and then executed by processor 702.

Generally describing an example configuration of the computer 700, the processor 702 may be a variety of various processors including dual microprocessor and other multi-processor architectures. A memory 704 may include volatile memory and/or non-volatile memory. Non-volatile memory may include, for example, ROM, PROM, and so on. Volatile memory may include, for example, RAM, SRAM, DRAM, and so on.

A disk 706 may be operably connected to the computer 700 via, for example, an input/output interface (e.g., card, device) 718 and an input/output port 710. The disk 706 may be, for example, a magnetic disk drive, a solid state disk drive, a floppy disk drive, a tape drive, a Zip drive, a flash memory card, a memory stick, and so on. Furthermore, the disk 706 may be a CD-ROM drive, a CD-R drive, a CD-RW drive, a DVD ROM drive, a Blu-Ray drive, an HD-DVD drive, and so on. The memory 704 can store a process 714 and/or a data 716, for example. The disk 706 and/or the memory 704 can store an operating system that controls and allocates resources of the computer 700.

The bus 708 may be a single internal bus interconnect architecture and/or other bus or mesh architectures. While a single bus is illustrated, it is to be appreciated that the computer 700 may communicate with various devices, logics, and peripherals using other busses (e.g., PCIE, 1394, USB, Ethernet). The bus 708 can be types including, for example, a memory bus, a memory controller, a peripheral bus, an external bus, a crossbar switch, and/or a local bus.

The computer 700 may interact with input/output devices via the i/o interfaces 718 and the input/output ports 710. Input/output devices may be, for example, a keyboard, a microphone, a pointing and selection device, cameras, video cards, displays, the disk 706, the network devices 720, and so on. The input/output ports 710 may include, for example, serial ports, parallel ports, and USB ports.

The computer 700 can operate in a network environment and thus may be connected to the network devices 720 via the i/o interfaces 718, and/or the i/o ports 710. Through the network devices 720, the computer 700 may interact with a network. Through the network, the computer 700 may be logically connected to remote computers. Networks with which the computer 700 may interact include, but are not limited to, a LAN, a WAN, and other networks.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, the invention is not limited to the specific details, the representative apparatus, and illustrative examples shown and described. Thus, this application is intended to embrace alterations, modifications, and variations that fall within the scope of the appended claims.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

To the extent that the phrase “one or more of, A, B, and C” is employed herein, (e.g., a data store configured to store one or more of, A, B, and C) it is intended to convey the set of possibilities A, B, C, AB, AC, BC, ABC, AAA, MB, AABB, MBBC, AABBCC, and so on (e.g., the data store may store only A, only B, only C, A&B, A&C, B&C, A&B&C, A&A&A, A&A&B, A&A&B&B, A&A&B&B&C, A&A&B&B&C&C, and so on). It is not intended to require one of A, one of B, and one of C. When the applicants intend to indicate “at least one of A, at least one of B, and at least one of C”, then the phrasing “at least one of A, at least one of B, and at least one of C” will be employed.

What is claimed is:

1. A computer-readable medium storing computer-executable instructions that when executed by a computer cause the computer to perform a method, the method comprising:
creating an alias email address upon detecting an initial provision of an un-aliased email address to an email address consumer;
establishing a relationship between the alias email address and the email address consumer; and
providing data associated with the email address consumer to a spam distinguishing entity upon receiving a reveal signal from the spam distinguishing entity, the reveal signal identifying the alias email address.

2. The computer-readable medium of claim 1, where the spam distinguishing entity is one of a user, and a logic.

3. The computer-readable medium of claim 1, where an email address consumer is one of, a web form, a destination of a web form, an outgoing email, a destination of an outgoing email, a product registration form, and a destination of a product registration form.

4. The computer-readable medium of claim 1, the method comprising:
updating a reputation system based, at least in part, on the reveal signal.

5. The computer-readable medium of claim 1, the method comprising:
performing a restrictive action associated with the alias email address upon receiving a block signal from the spam distinguishing entity identifying the alias email address; and
updating a reputation system based, at least in part, on the block signal.

6. The computer-readable medium of claim 5, where the restrictive action is one of, configuring an email filter associated with the alias email address, blocking an incoming signal associated with the alias email address, modifying a routing setting to block an incoming signal associated with the alias email address, and applying a sieve algorithm to a signal associated with the alias email address.

7. The computer-readable medium of claim 1, the method comprising:
replacing an occurrence of the un-aliased email address with the alias email address upon detecting a subsequent provision of the un-aliased email address to the email address consumer.

8. The computer-readable medium of claim 7, where replacing the occurrence of the un-aliased email address is based, at least in part, on the relationship between the alias email address and the email address consumer.

9. The computer-readable medium of claim 1, the method comprising:
storing data associated with a source of an incoming email address upon determining that the incoming email address identifies the alias email address.

10. The computer-readable medium of claim 9, the method comprising:
replacing an occurrence of the un-aliased email address with the alias email address upon detecting a provision of the un-aliased email address to the source of the incoming email address, where the replacement is based, at least in part, on the data associated with the source of the incoming email address.

11. The computer-readable medium of claim 1, where the reveal signal indicates that undesirable email traffic has been received by the alias email address.

12. The computer-readable medium of claim 4, where the reputation system facilitates identifying an email address consumer that is associated with unsolicited commercial email.

13. The computer-readable medium of claim 1, comprising replacing an occurrence of the alias email address with the un-aliased email address in an incoming signal.

14. A computer-readable medium storing computer-executable instructions that when executed by a computer cause the computer to perform a method, the method comprising:
detecting a provision of an email address to an email address consumer; and
warning a user that the email address consumer may be associated with undesirable email traffic upon determining that the email address consumer satisfies a spam standard based, at least in part, on data acquired from a reputation system.

15. The computer-readable medium of claim 14, where the data acquired from the reputation system is stored in a memory accessible by the computer.

16. The computer-readable medium of claim 14, where the data acquired from the reputation system is provided by the reputation system in response to a request.

17. The computer-readable medium of claim 14, the method comprising controlling the reputation system to update data associated with a revealed email address consumer in response to receiving a reveal signal from the user, the reveal signal identifying the revealed email address consumer.

18. The computer-readable medium of claim 14, the method comprising controlling the reputation system to update data associated with a blocked email address consumer in response to receiving a block signal from the user, the block signal identifying the blocked email address consumer.

19. A system, comprising:
an email tracking logic to manage a set of signals associated with an email address;
a reputation system control logic to control a reputation system to update data associated with a tracked email address consumer based, at least in part, on the set of signals associated with the email address; and
a warning logic to warn a user that a recipient email address consumer may be associated with undesirable email traffic upon detecting a provision of the email address to the recipient email address consumer and upon determining that the recipient email address consumer satisfies a spam standard based, at least in part, on data from the reputation system.

20. The system of claim 19, where the email tracking logic manages the set of signals by:
creating an alias email address when a user attempts to provide an un-aliased email address to the tracked email address consumer;
storing an association between the alias email address and the tracked email address consumer;
performing an action associated with the tracked email address consumer in response to receiving an action signal from a user, the action signal identifying the alias email address; and
initiating the reputation system control logic in response to the action signal.

21. The system of claim 20, where the action signal is one of, a reveal signal, and a block signal and where the action is one of, providing data associated with the tracked email address consumer to the user, and performing a restrictive action associated with the alias email address.

22. A system, comprising:
means for managing signals associated with an email address;
means for controlling a reputation system based, at least in part, on the signals associated with the email address; and
means for warning a user that an email address consumer may be associated with undesirable email traffic based, at least in part, on data from the reputation system.
